(19) United States
(12) Patent Application Publication
(10) Pub. No.: US 2026/0131294 A1
(43) Pub. Date: May 14, 2026

(54) GAS MIXING DEVICE

(71) Applicant: HONDA MOTOR CO., LTD., Tokyo (JP)

(72) Inventors: Misato Shimizu, Wako-shi (JP); Yuichi Fukuchi, Wako-shi (JP)

(21) Appl. No.: 19/380,036

(22) Filed: Nov. 5, 2025

(30) Foreign Application Priority Data
Nov. 11, 2024 (JP) 2024-196554

(51) Int. Cl. B01F 25/314; B01F 23/10; B01F 35/00; B01F 35/90; B01F 35/91; F01N 3/05

(52) U.S. Cl. CPC B01F 25/31422; B01F 23/10; B01F 25/3143; B01F 35/55; B01F 35/91; F01N 3/05; B01F 2035/98

(57) ABSTRACT

A gas mixing device mixes an exhaust gas discharged from an internal combustion engine with a cooling gas introduced from the outside of the internal combustion engine. The gas mixing device includes a tubular portion, and a cooling gas inlet port for introducing the cooling gas into a space located outside the tubular portion. One end portion of the tubular portion is provided with an exhaust gas inlet port, and the other end portion of the tubular portion is provided with a mixed gas outlet port for leading out a mixed gas of the exhaust gas and the cooling gas. A plurality of opening portions allowing the cooling gas in the space to flow into the inside of the tubular portion are formed in a peripheral wall of the tubular portion, and positions of the opening portions in the axial direction of the tubular portion are different from each other.

### CROSS-REFERENCE TO RELATED APPLICATIONS

This application is based upon and claims the benefit of priority from Japanese Patent Application No. 2024-196554 filed on Nov. 11, 2024, the contents of which are incorporated herein by reference.

### BACKGROUND OF THE INVENTION

### Field of the Invention

The present disclosure relates to a gas mixing device.

### Description of the Related Art

In recent years, technological developments have been conducted on gas mixing devices that contribute to energy efficiency in order to ensure that more people have access to affordable, reliable, sustainable and modern energy.

JP 2005-507044 A discloses a gas mixing device for mixing a cooling gas with an exhaust gas discharged from a gas turbine engine.

### SUMMARY OF THE INVENTION

There has been a demand for a gas mixing device capable of mixing an exhaust gas and a cooling gas well.

The present disclosure has the object of solving the above-described problem.

According to one aspect of the present disclosure, there is provided a gas mixing device that mixes an exhaust gas discharged from an internal combustion engine and a cooling gas introduced from an outside of the internal combustion engine, the gas mixing device comprising: a tubular portion; and a cooling gas inlet port configured to introduce the cooling gas into a space located outside the tubular portion, wherein one end portion of the tubular portion is provided with an exhaust gas inlet port configured to introduce the exhaust gas into an inside of the tubular portion, another end portion of the tubular portion is provided with a mixed gas outlet port configured to lead out a mixed gas in which the exhaust gas and the cooling gas are mixed, a plurality of opening portions configured to allow the cooling gas in the space to flow into the inside of the tubular portion are formed in a peripheral wall of the tubular portion, and positions of the plurality of opening portions in an axial direction of the tubular portion are different from each other.

According to the present disclosure, it is possible to provide a gas mixing device capable of mixing an exhaust gas and a cooling gas well.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a moving object including a gas mixing device;

FIG. 2 is a schematic diagram of a power generation module including the gas mixing device;

FIG. 3 is a partially omitted perspective view of the gas mixing device;

FIG. 4 is a partially omitted schematic plan view of the gas mixing device;

FIG. 5 is a transverse cross-sectional view taken along line V-V of FIG. 4;

FIG. 6 is a transverse cross-sectional view taken along line VI-VI of FIG. 4;

FIG. 7 is a perspective view of a tubular portion;

FIG. 8 is a development view of the tubular portion;

FIG. 9 is an explanatory view showing the flow of an exhaust gas and a cooling gas;

FIG. 10 is an explanatory view showing the flow of the cooling gas;

FIG. 11 is a cross-sectional explanatory view of a gas mixing device according to a modification;

FIG. 12 is an explanatory view of a vortex generation suppressing wall according to the modification; and

FIG. 13 is an explanatory view of the vortex generation suppressing wall according to the modification.

### DETAILED DESCRIPTION OF THE INVENTION

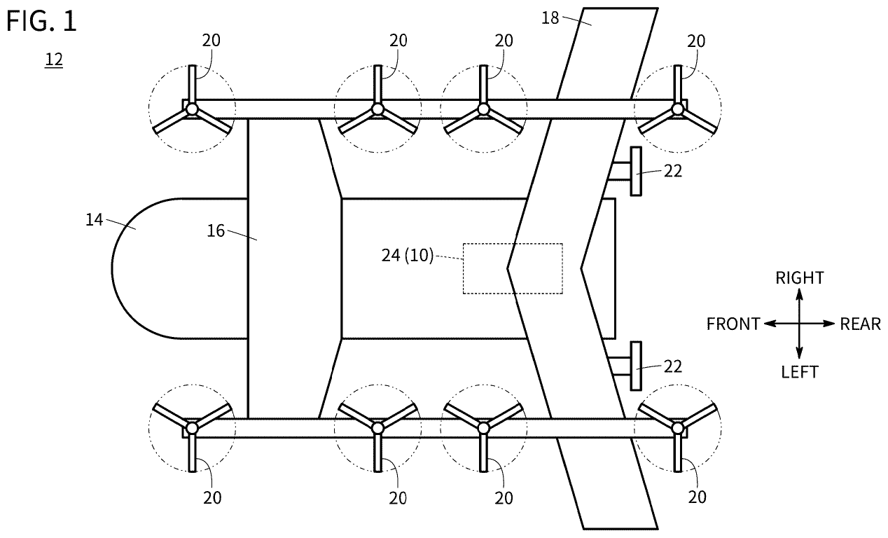

A gas mixing device 10 according to an embodiment of the present disclosure will be described below with reference to the drawings. FIG. 1 is a schematic diagram of a moving object 12 including the gas mixing device 10. As shown in FIG. 1, the gas mixing device 10 according to the present embodiment is mounted on, for example, an aircraft as the moving object 12. The aircraft may be, for example, an electric vertical take-off and landing aircraft (eVTOL). The moving object 12 may be, for example, a ship, a vehicle, or the like.

The moving object 12 includes a fuselage 14, a front wing portion 16, a rear wing portion 18, eight VTOL rotors 20, and two cruise rotors 22. The fuselage 14 extends in the front-rear direction of the aircraft. The front wing portion 16 is provided at a portion forward of the center of the fuselage 14 in the front-rear direction. The rear wing portion 18 is provided at a portion rearward of the center of the fuselage 14 in the front-rear direction. The VTOL rotors 20 generate upward thrust for the aircraft. The cruise rotors 22 generate horizontal thrust for the aircraft. The two cruise rotors 22 are attached to the rear wing portion 18. The number and arrangement of the VTOL rotors 20 and the cruise rotors 22 can be set as appropriate.

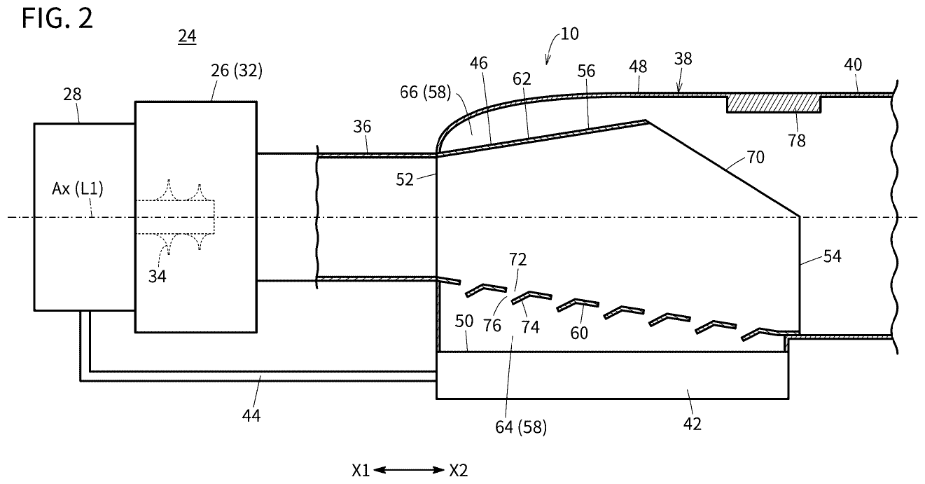

A power generation module 24 is disposed inside the fuselage 14. FIG. 2 is a schematic diagram of the power generation module 24 including the gas mixing device 10. As shown in FIG. 2, the power generation module 24 includes an internal combustion engine 26, a generator 28, and the gas mixing device 10. The internal combustion engine 26 is, for example, a gas turbine engine 32, but is not limited thereto.

The gas turbine engine 32 is an axial gas turbine engine. In this case, the flow velocity of the exhaust gas discharged from the gas turbine engine 32 tends to be higher on the radially outer side than on the radially inner side. Note that the gas turbine engine 32 may be a radial gas turbine engine. Even when the gas turbine engine 32 is a radial gas turbine engine, the flow velocity of the exhaust gas discharged from the gas turbine engine 32 may be higher on the radially outer side than on the radially inner side. The gas turbine engine 32 generates high-temperature combustion gas by burning fuel. The combustion gas causes a turbine 34 of the gas turbine engine 32 to rotate.

The generator 28 is connected to the turbine 34. The generator 28 generates electric power by rotation of the turbine 34. The electric power generated by the generator 28 is supplied to electric equipment. Examples of the electric equipment may include, for example, electric motors for driving the VTOL rotors 20 and the cruise rotors 22 shown in FIG. 1. Further, the electric equipment may include batteries, inverters, and the like. The generator 28 is disposed in an X1 direction with respect to the gas turbine engine 32.

The gas turbine engine 32 discharges high-temperature exhaust gas in an X2 direction as a result of rotation of the turbine 34. The X2 direction is a direction opposite to the X1 direction. The exhaust gas flows in a vortex shape around an axis Ax of the turbine 34. In other words, the exhaust gas contains a swirling component. The swirling direction of the swirling component of the exhaust gas is, for example, counterclockwise when viewed from the X1 direction.

The gas mixing device 10 is connected to the gas turbine engine 32. The gas mixing device 10 is located in the X2 direction with respect to the gas turbine engine 32. The gas mixing device 10 cools the exhaust gas by mixing a cooling gas having flowed through a radiator 42 (described later) with the exhaust gas discharged from the gas turbine engine 32. The gas mixing device 10 according to the present embodiment can efficiently mix the cooling gas with the exhaust gas in the case where the flow velocity of the exhaust gas on the radially outer side is higher than the flow velocity of the exhaust gas on the radially inner side. The mixed gas in which the exhaust gas and the cooling gas are mixed is discharged to the outside of the fuselage 14.

The gas mixing device 10 includes an exhaust pipe 36, a gas mixing unit 38, and a mixed gas discharge pipe 40. The exhaust pipe 36 extends in the X2 direction from the gas turbine engine 32.

The gas mixing unit 38 is disposed downstream of the exhaust pipe 36. The gas mixing unit 38 is provided with the radiator 42. A cooling pipe 44 through which a cooling medium for cooling the generator 28 flows is connected to the radiator 42. Outside air can flow through the radiator 42. The radiator 42 exchanges heat between the outside air and the cooling medium guided from the cooling pipe 44. In other words, the radiator 42 cools the cooling medium with the outside air.

The outside air that has flowed through the radiator 42 is warmed by the cooling medium. However, the temperature of the outside air that has flowed through the radiator 42 is lower than the temperature of the exhaust gas. That is, the outside air that has flowed through the radiator 42 can be a cooling gas for cooling the exhaust gas. Hereinafter, the outside air that has flowed through the radiator 42 is referred to as a cooling gas. It should be noted that, although the present embodiment shows an example in which the outside air is made to flow through the radiator 42, the gas mixing device 10 may not be provided with the radiator 42. In this case, the outside air that does not flow through the radiator 42 (the outside air introduced from the outside of the internal combustion engine 26) can be used as the cooling gas.

The gas mixing unit 38 includes a tubular portion 46, an accommodating portion 48, and a cooling gas inlet port 50. The tubular portion 46 is formed in a cylindrical shape. The axis of the tubular portion 46 and the axis of the exhaust pipe 36 coincide with an extension line L1 of the axis Ax of the turbine 34.

An exhaust gas inlet port 52 for introducing the exhaust gas into the inside of the tubular portion 46 is provided at one end portion (an end portion in the X1 direction) of the tubular portion 46. A mixed gas outlet port 54 for leading out a mixed gas in which the exhaust gas and the cooling gas are mixed is provided at the other end portion (an end portion in the X2 direction) of the tubular portion 46. That is, the exhaust gas flows from the one end portion toward the other end portion of the tubular portion 46 while swirling inside the tubular portion 46.

The tubular portion 46 increases in diameter from the one end portion toward the other end portion of the tubular portion 46 (toward the X2 direction). This makes it possible to efficiently create a negative pressure inside the tubular portion 46. The detailed configuration of the tubular portion 46 will be described later.

The accommodating portion 48 accommodates the tubular portion 46. The accommodating portion 48 covers a peripheral wall 56 of the tubular portion 46 from the radially outer side. A space 58 outside the tubular portion 46 extends in an annular shape so as to surround the peripheral wall 56 of the tubular portion 46. The cooling gas inlet port 50 introduces the cooling gas into the space 58 located outside the tubular portion 46. The cooling gas inlet port 50 is provided in the accommodating portion 48. In other words, the cooling gas inlet port 50 is a hole formed in the accommodating portion 48. The cooling gas that has flowed through the radiator 42 is sucked into the space 58 located between the peripheral wall 56 of the tubular portion 46 and the accommodating portion 48 via the cooling gas inlet port 50 due to the inside of the tubular portion 46 being placed into the negative pressure state.

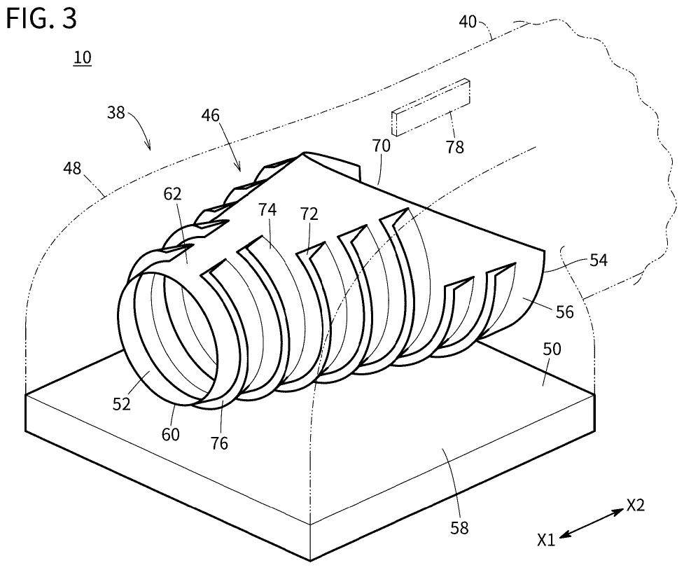

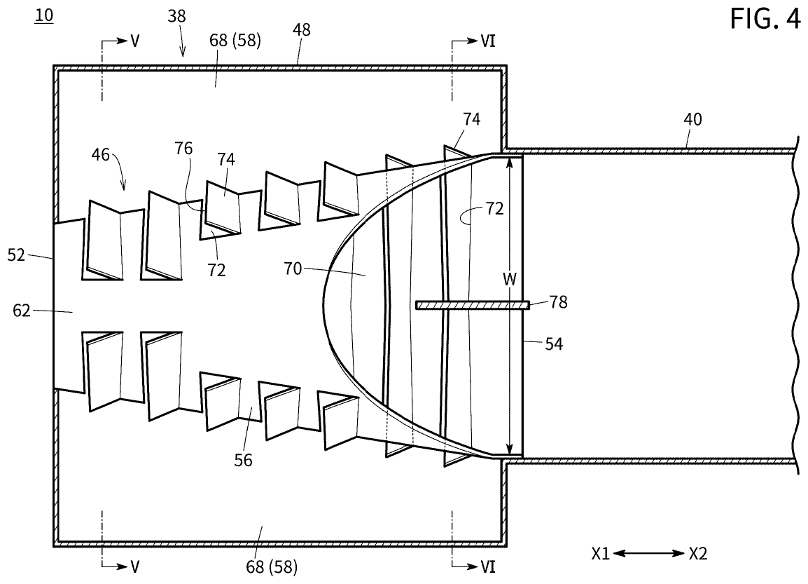

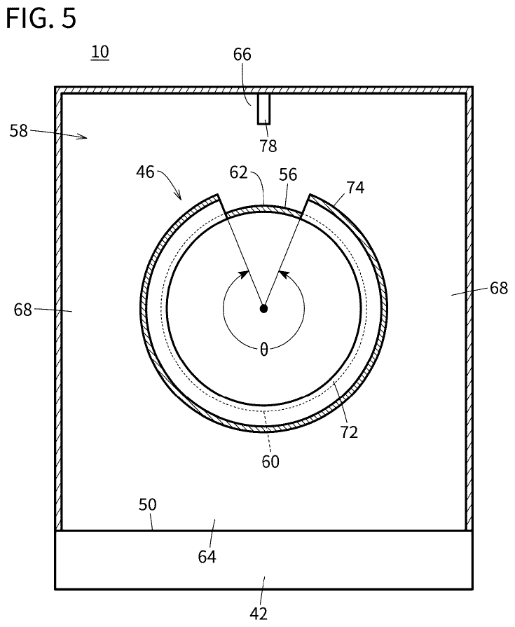

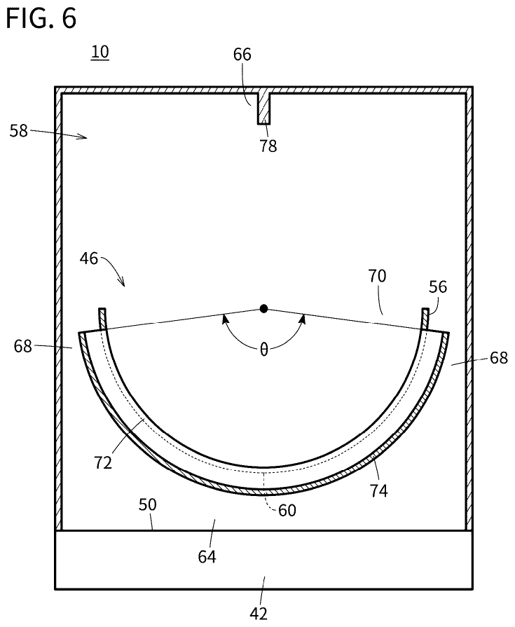

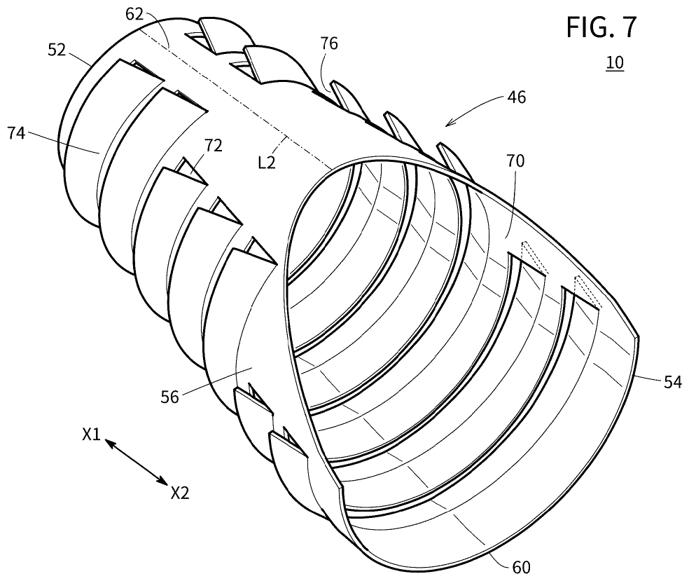

FIG. 3 is a partially omitted perspective view of the gas mixing device 10. FIG. 4 is a partially omitted schematic plan view of the gas mixing device 10. FIG. 5 is a transverse cross-sectional view taken along line V-V of FIG. 4. FIG. 6 is a transverse cross-sectional view taken along line VI-VI of FIG. 4. FIG. 7 is a perspective view of the tubular portion 46.

As shown in FIGS. 2 to 7, the tubular portion 46 is formed in a cylindrical shape. The peripheral wall 56 of the tubular portion 46 includes a first part 60 and a second part 62. The first part 60 is located at a portion closest to the cooling gas inlet port 50 in the circumferential direction of the tubular portion 46. The second part 62 is located at a portion farthest from the cooling gas inlet port 50 in the circumferential direction of the tubular portion 46. That is, the second part 62 is located at a position shifted by 180 degrees from the first part 60 in the circumferential direction of the tubular portion 46.

As shown in FIGS. 5 and 6, the space 58 includes a first space 64, a second space 66, and a pair of communicating spaces 68. The first space 64 is formed between the tubular portion 46 and the cooling gas inlet port 50. The first space 64 is located outside the first part 60. The second space 66 is located outside the second part 62. Each of the pair of communicating spaces 68 allows the first space 64 and the second space 66 to communicate with each other. The communicating spaces 68 are located outside the portions of the peripheral wall 56 of the tubular portion 46 that connect the first part 60 and the second part 62.

As shown in FIGS. 2 to 4, the peripheral wall 56 of the tubular portion 46 is provided with a cutout portion 70, a plurality of opening portions 72, and a plurality of restricting walls 74.

As shown in FIGS. 2 to 4 and 7, the cutout portion 70 guides the cooling gas inside the space 58 between the peripheral wall 56 of the tubular portion 46 and the accommodating portion 48, to the inside of the tubular portion 46. The cutout portion 70 is formed in a part of the peripheral wall 56 of the tubular portion 46, the part facing the opposite side to the cooling gas inlet port 50. The cutout portion 70 is provided in the second part 62 of the peripheral wall 56 of the tubular portion 46. The cutout portion 70 is provided at the other end portion of the tubular portion 46. The cutout portion 70 extends from the other end portion toward the one end portion of the tubular portion 46 (toward the X1 direction). An end of the cutout portion 70 in the X1 direction is located at an intermediate portion of the tubular portion 46 in the axial direction (a central portion of the tubular portion 46 in the axial direction).

As shown in FIG. 4, a cutout width W of the cutout portion 70 decreases from the other end portion toward the one end portion of the tubular portion 46. In a plan view of the tubular portion 46 as viewed from the side opposite to the cooling gas inlet port 50, the outline (outer shape) of the cutout portion 70 includes a portion protruding in the X1 direction in an arc shape. As shown in FIG. 2, the end of the cutout portion 70 in the X1 direction is located at the second part 62 of the tubular portion 46. The cutout portion 70 is inclined with respect to the axis of the tubular portion 46. The cutout portion 70 is preferably formed such that, in a side view of the tubular portion 46, the inner surface of the tubular portion 46 is not visible and the outline (outer shape) of the cutout portion 70 extends in a straight line. In other words, the cutout portion 70 is preferably formed such that, in the side view of the tubular portion 46, the outline of the cutout portion 70 extends in a straight line from the end of the cutout portion 70 in the X1 direction to the end of thereof in the X2 direction. In this case, the cooling gas can be efficiently mixed with the exhaust gas. The opening area of the cutout portion 70 is larger than the opening area of each of the opening portions 72, but the present disclosure is not limited thereto.

As shown in FIGS. 2 to 7, the plurality of opening portions 72 allow the cooling gas inside the space 58 to flow into the inside of the tubular portion 46. The positions of the plurality of opening portions 72 in the axial direction of the tubular portion 46 are different from each other. The plurality of opening portions 72 are arranged at intervals in the axial direction of the tubular portion 46. That is, the plurality of opening portions 72 are lined up in the axial direction of the tubular portion 46.

As shown in FIGS. 3 and 5 to 7, the opening portions 72 extend in the circumferential direction of the tubular portion 46. The opening portions 72 extend in a band shape. The plurality of opening portions 72 are not connected to the cutout portion 70. Further, the plurality of opening portions 72 are not connected to each other.

As shown in FIGS. 5 and 6, the opening portions 72 each extend in an arc shape along the circumferential direction of the tubular portion 46 such that a central angle θ is a predetermined angle. Among the plurality of opening portions 72, the opening portion 72 located further in the X1 direction has a larger central angle θ. Specifically, as shown in FIG. 5, the central angle θ of the opening portion 72 located in the vicinity of the one end portion of the tubular portion 46 can be set to, for example, 300 degrees or more and 350 degrees or less. In this case, the opening portion 72 is not formed in the second part 62 of the tubular portion 46.

Inside the tubular portion 46, the exhaust gas has the lowest pressure at a position in the vicinity of the exhaust gas inlet port 52 (at the end portion of the tubular portion 46 in the X1 direction). When the central angle θ of the opening portion 72 located in the vicinity of the one end portion of the tubular portion 46 is 300 degrees or more, the cooling gas can be efficiently drawn into a portion having a relatively large negative pressure (a portion having a relatively low pressure) inside the tubular portion 46. Therefore, the cooling gas and the exhaust gas can be mixed well. Further, when the central angle θ of the opening portion 72 located in the vicinity of the one end portion of the tubular portion 46 is 350 degrees or less, it is possible to suppress an excessive decrease in the rigidity in the vicinity of the one end portion of the tubular portion 46.

As shown in FIG. 6, the central angle θ of the opening portion 72 located in the vicinity of the other end portion of the tubular portion 46 can be set to, for example, 180 degrees or less. The central angle θ of the opening portion 72 located in the intermediate portion of the tubular portion 46 in the axial direction is larger than the central angle θ of the opening portion 72 located in the vicinity of the other end portion of the tubular portion 46 and smaller than the central angle θ of the opening portion 72 located in the vicinity of the one end portion of the tubular portion 46 (see FIGS. 3 and 7). According to such a configuration, it is possible to form the cutout portion 70 in the vicinity of the other end portion of the tubular portion 46 while suppressing a decrease in the rigidity of the tubular portion 46.

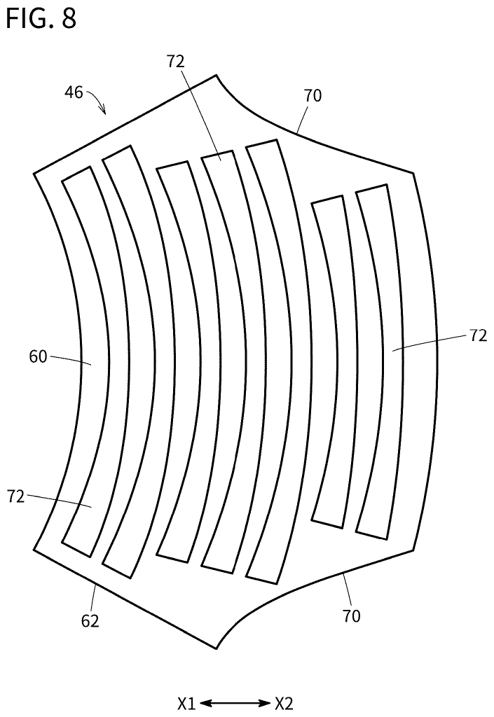

FIG. 8 is a development view of the tubular portion 46. Specifically, FIG. 8 is a development view obtained by cutting the tubular portion 46 shown in FIG. 7 at the position of a line L2. Note that, in FIG. 8, illustration of the restricting walls 74 is omitted.

As shown in FIGS. 3, 4, 7 and 8, the opening width of the opening portion 72 along the axial direction of the tubular portion 46 increases with increasing distance from the cooling gas inlet port 50. In other words, the opening width of the opening portion 72 increases from the first part 60 toward the second part 62 of the tubular portion 46.

As shown in FIGS. 2 to 4 and 7, the plurality of restricting walls 74 are louvers that restrict the inflow direction of the cooling gas flowing into the inside of the tubular portion 46 from the space 58 via the opening portions 72. Specifically, the restricting walls 74 restrict the inflow direction of the cooling gas to a direction lying along the X2 direction.

The restricting walls 74 protrude from the peripheral wall 56 of the tubular portion 46 toward the space 58. The restricting walls 74 are provided so as to cover the opening portions 72 from the outside of the tubular portion 46. Intake ports 76 for taking in the cooling gas are provided between end portions of the restricting walls 74 in the protruding direction thereof and the peripheral wall 56 of the tubular portion 46.

The intake ports 76 are directed in a direction from the other end portion toward the one end portion of the tubular portion 46 (the X1 direction). That is, the restricting walls 74 protrude from the peripheral wall 56 of the tubular portion 46 toward the X1 direction. The restricting walls 74 are inclined with respect to the axis of the tubular portion 46. It should be noted that, in the case where the tubular portion 46 increases in diameter toward the X2 direction as in the present embodiment, the restricting walls 74 may extend parallel to the axis of the tubular portion 46.

As shown in FIGS. 3 and 7, the restricting walls 74 extend along the circumferential direction of the tubular portion 46. The restricting walls 74 extend along the opening portions 72. The restricting walls 74 each cover the opening portion 72 from one end to the other end thereof in the extending direction. The shape of the restricting walls 74 corresponds to the shape of the opening portions 72. The size of the restricting walls 74 corresponds to the size of the opening portions 72. The position, size, shape, and the like of the restricting walls 74 can be set as appropriate.

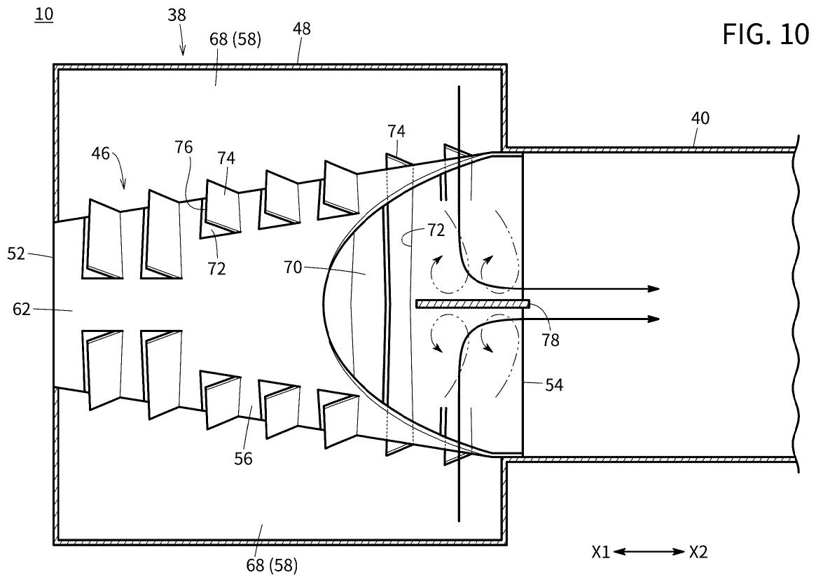

In the gas mixing device 10, the flow velocity of the exhaust gas is higher than the flow velocity of the cooling gas. In such a case, as shown by imaginary lines in FIG. 10, a vortex of the cooling gas may be generated at a portion where the exhaust gas and the cooling gas are mixed. Specifically, a vortex in a transverse direction (a transverse vortex) with respect to the flow direction of the exhaust gas may be generated. When such a vortex is generated, the cooling gas is likely to stay.

As shown in FIGS. 2 to 4, in the present embodiment, the gas mixing device 10 includes a vortex generation suppressing wall 78 that can suppress generation of a vortex of the cooling gas in the space 58. The vortex generation suppressing wall 78 and the cooling gas inlet port 50 are located on opposite sides of the tubular portion 46. That is, the vortex generation suppressing wall 78 is located in the second space 66. The vortex generation suppressing wall 78 is a protrusion protruding from the inner surface of the accommodating portion 48. The vortex generation suppressing wall 78 is located so as to face the cutout portion 70. The vortex generation suppressing wall 78 is a guide vane extending in a plate shape along the axial direction of the tubular portion 46.

The position, size, shape, and the like of the vortex generation suppressing wall 78 can be set as appropriate. That is, for example, in the case where the vortex of the cooling gas can be expected to be generated in the communicating space 68, the vortex generation suppressing wall 78 may be provided in the communicating space 68. Further, for example, in the case where the vortex of the cooling gas can be expected to be generated in the vicinity of the other end portion of the tubular portion 46, the vortex generation suppressing wall 78 may be provided inside the mixed gas discharge pipe 40.

As shown in FIG. 2, the mixed gas discharge pipe 40 is disposed downstream of (in the X2 direction with respect to) the tubular portion 46. The mixed gas guided from the mixed gas outlet port 54 of the tubular portion 46 is discharged to the outside of the fuselage 14 through the mixed gas discharge pipe 40. One end portion of the mixed gas discharge pipe 40 is joined to the other end portion of the tubular portion 46.

The mixed gas discharge pipe 40 may be a diffuser whose inner diameter increases toward the X2 direction. In this case, a negative pressure is easily generated inside the tubular portion 46. In the case where the mixed gas discharge pipe 40 is a diffuser, the inside of the tubular portion 46 can be placed into a negative pressure state even if the inner diameter of the tubular portion 46 is formed to be constant from the one end portion to the other end portion of the tubular portion 46.

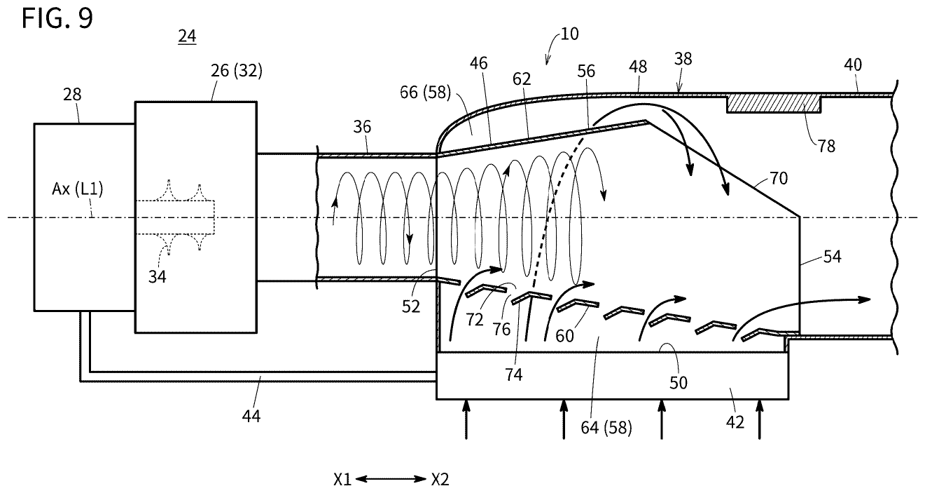

Next, the flow of the exhaust gas and the cooling gas in the gas mixing device 10 will be described. FIG. 9 is an explanatory view showing the flow of the exhaust gas and the cooling gas. FIG. 10 is an explanatory view showing the flow of the cooling gas.

As shown in FIG. 9, the high-temperature exhaust gas discharged from the gas turbine engine 32 is introduced, via the exhaust pipe 36, into the inside of the tubular portion 46 from the exhaust gas inlet port 52. Since the inner diameter of the tubular portion 46 increases from the one end portion toward the other end portion of the tubular portion 46, the inside of the tubular portion 46 is placed into a negative pressure state. Then, the outside air is guided to the radiator 42 by the suction force generated inside the tubular portion 46. In the radiator 42, heat is exchanged between the outside air and the cooling medium flowing through the cooling pipe 44. The temperature of the outside air warmed by the heat exchange is well below the temperature of the exhaust gas discharged from the gas turbine engine 32. Therefore, the outside air serves as a cooling gas for the exhaust gas.

The cooling gas is guided from the cooling gas inlet port 50 to the first space 64 by the suction force. The cooling gas guided to the first space 64 flows into the inside of the tubular portion 46 via the intake ports 76 and the opening portions 72. At this time, the flow direction of the cooling gas lies along the X2 direction. In this case, it is possible to make the cooling gas smoothly flow into the inside of the tubular portion 46. That is, it is possible to suppress a situation in which the flow of the exhaust gas is hindered by the cooling gas. Further, since the positions of the plurality of opening portions 72 in the axial direction of the tubular portion 46 are different from each other, it is possible to make the cooling gas flow into the inside of the tubular portion 46 in the axial direction of the tubular portion 46 in a balanced manner.

A portion of the cooling gas guided to the first space 64 is guided to the second space 66 via the pair of communicating spaces 68. The cooling gas in the communicating spaces 68 and the second space 66 flows into the inside of the tubular portion 46 via the intake ports 76 and the opening portions 72, in the same manner as the cooling gas in the first space 64. This allows the cooling gas to flow into the inside of the tubular portion 46 in the circumferential direction of the tubular portion 46 in a balanced manner.

Further, the cooling gas guided to the communicating spaces 68 and the second space 66 flows into the inside of the tubular portion 46 via the cutout portion 70. This allows the cooling gas in the second space 66 to flow smoothly. In this case, since the situation in which the cooling gas stays inside the second space 66 can be suppressed, it is possible to make the cooling gas in the first space 64 smoothly flow into the second space 66 via the communicating spaces 68.

Further, since the gas mixing device 10 includes the vortex generation suppressing wall 78, it is possible to suppress the generation of a vortex (vortex of the cooling gas) as indicated by the imaginary lines shown in FIG. 10 around the cutout portion 70. As a result, since the situation in which the cooling gas stays in the second space 66 can be suppressed, it is possible to make the cooling gas in the second space 66 smoothly flow into the inside of the tubular portion 46 via the cutout portion 70.

The exhaust gas and the cooling gas are mixed inside the tubular portion 46. The mixed gas in which the exhaust gas and the cooling gas are mixed is discharged from the mixed gas outlet port 54 of the tubular portion 46 to the outside of the fuselage 14 via the mixed gas discharge pipe 40. As result, since the exhaust gas of the gas turbine engine 32 can be smoothly discharged, the gas turbine engine 32 (the internal combustion engine 26) can be efficiently driven.

According to the present embodiment, since the positions of the plurality of opening portions 72 in the axial direction of the tubular portion 46 are different from each other, it is possible to make the cooling gas flow into the inside of the tubular portion 46 in the axial direction of the tubular portion 46 in a balanced manner. Therefore, the cooling gas and the exhaust gas can be efficiently mixed. Accordingly, the more satisfactory gas mixing device 10 and the more satisfactory moving object 12 can be provided.

### Modification

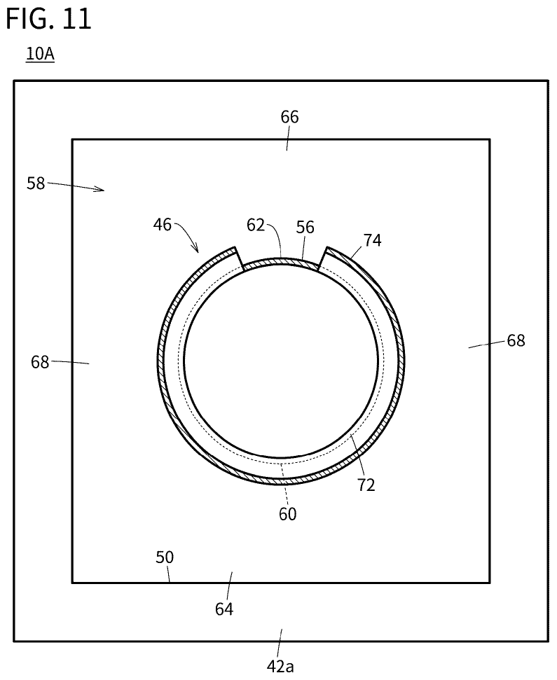

FIG. 11 is a cross-sectional view of a gas mixing device 10A according to a modification. As shown in FIG. 11, the gas mixing device 10A may be provided with a radiator 42a instead of the radiator 42. The radiator 42a is formed in an annular shape so as to surround the peripheral wall 56 of the tubular portion 46 from the outside. Further, the cooling gas inlet port 50 is formed in an annular shape on the outer side so as to surround the peripheral wall 56 of the tubular portion 46. In this case, the cooling gas is directly introduced from the cooling gas inlet port 50 into the entire space 58 (the first space 64, the second space 66, and the communicating spaces 68).

This allows the cooling gas to flow into the inside of the tubular portion 46 in the circumferential direction of the tubular portion 46 in a more balanced manner. In the present embodiment, the opening width of each of the opening portions 72 of the tubular portion 46 is constant over the entire length of the opening portion 72. The gas mixing device 10A according to the modification has the same effects as the gas mixing device 10 described above.

The present embodiment is not limited to the configuration described above. The gas mixing devices 10 and 10A may not include the vortex generation suppressing wall 78. In addition, the tubular portion 46 may be provided with only the cutout portion 70 without being provided with the plurality of opening portions 72. The tubular portion 46 may be provided with the plurality of opening portions 72 without being provided with the cutout portion 70. Each of the opening portions 72 is not limited to a single hole formed in a band shape in the circumferential direction of the tubular portion 46, and may be formed of, for example, a plurality of holes provided at intervals in the circumferential direction of the tubular portion 46.

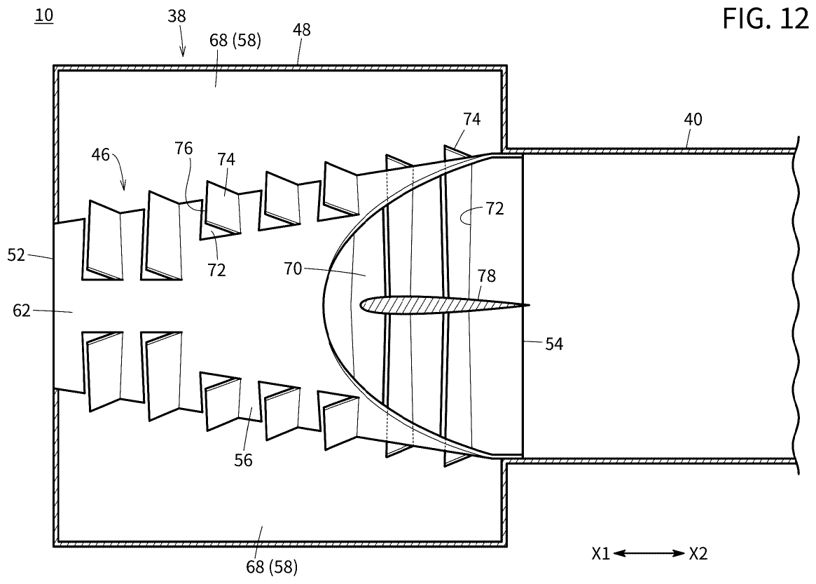

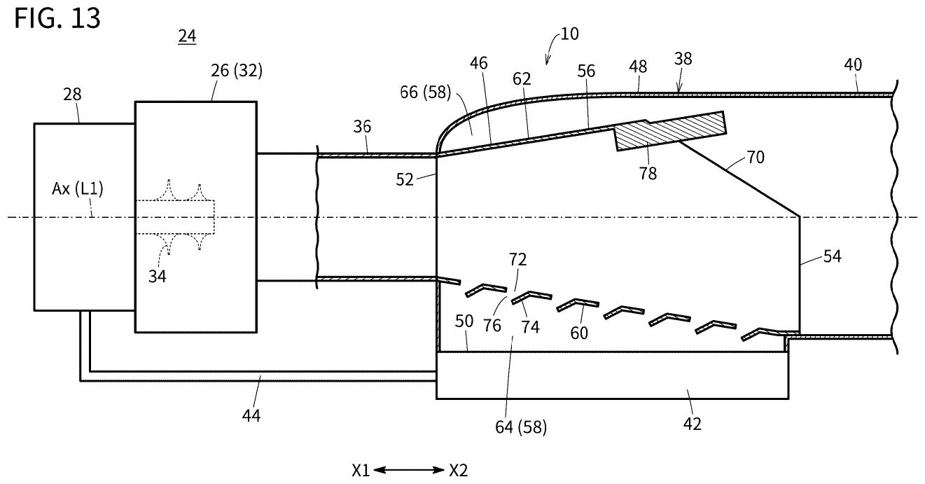

In the present embodiment, the vortex generation suppressing wall 78 may be formed in a wing shape in a plan view as shown in FIG. 12. In this case, the generation of the vortex can be efficiently suppressed. The vortex generation suppressing wall 78 is not limited to being provided on the inner surface of the accommodating portion 48. The vortex generation suppressing wall 78 may be provided in any member as long as it is inside the accommodating portion 48. That is, as shown in FIG. 13, the vortex generation suppressing wall 78 may be provided in the tubular portion 46. In this case, the vortex generation suppressing wall 78 can be provided in the tubular portion 46 so as to protrude outward from the tubular portion 46, for example. Further, a plurality of the vortex generation suppressing walls 78 may be provided inside the accommodating portion 48. A plurality of the second parts 62 may be provided in the circumferential direction of the tubular portion 46.

The following supplementary notes are further disclosed in relation to the above-described embodiments.

### Supplementary Note 1

The gas mixing device (10, 10A) of the present disclosure is characterized by a gas mixing device that mixes an exhaust gas discharged from the internal combustion engine (26) and a cooling gas introduced from the outside of the internal combustion engine, the gas mixing device including: the tubular portion (46); and the cooling gas inlet port (50) configured to introduce the cooling gas into the space (58) located outside the tubular portion, wherein one end portion of the tubular portion is provided with the exhaust gas inlet port (52) configured to introduce the exhaust gas into an inside of the tubular portion, the other end portion of the tubular portion is provided with the mixed gas outlet port (54) configured to lead out a mixed gas in which the exhaust gas and the cooling gas are mixed, the plurality of opening portions (72) configured to allow the cooling gas in the space to flow into the inside of the tubular portion are formed in the peripheral wall (56) of the tubular portion, and positions of the plurality of opening portions in the axial direction of the tubular portion are different from each other.

According to such a configuration, since the positions of the plurality of opening portions in the axial direction of the tubular portion are different from each other, it is possible to make the cooling gas flow into the inside of the tubular portion in the axial direction of the tubular portion in a balanced manner. Therefore, the cooling gas and the exhaust gas can be efficiently mixed. Accordingly, a more satisfactory gas mixing device can be provided.

### Supplementary Note 2

The gas mixing device according to Supplementary Note 1 may further include the accommodating portion (48) configured to accommodate the tubular portion, and the cooling gas inlet port may be provided in the accommodating portion so as to face the peripheral wall of the tubular portion.

According to such a configuration, the cooling gas guided from the cooling gas inlet port can be efficiently guided to the opening portions formed in the peripheral wall.

### Supplementary Note 3

In the gas mixing device according to Supplementary Note 2, the cutout portion (70) may be formed in a part of the peripheral wall of the tubular portion, the part facing the side opposite to the cooling gas inlet port.

According to such a configuration, the air around the portion of the peripheral wall of the tubular portion that faces the side opposite to the cooling gas inlet port can be made to flow into the inside of the tubular portion via the cutout portion. As a result, it is possible to make the cooling gas flow into the inside of the tubular portion in the circumferential direction of the tubular portion in a balanced manner by using the cutout portion.

### Supplementary Note 4

In the gas mixing device according to Supplementary Note 3, the cutout portion may be provided in the other end portion of the tubular portion.

According to such a configuration, it is possible to make the cooling gas efficiently flow into the inside of the other end portion of the tubular portion.

### Supplementary Note 5

In the gas mixing device according to Supplementary Note 4, the cutout width (W) of the cutout portion may decrease from the other end portion toward the one end portion of the tubular portion.

According to such a configuration, it is possible to suppress an excessive decrease in the rigidity of the intermediate portion of the tubular portion in the axial direction due to the cutout portion.

### Supplementary Note 6

In the gas mixing device according to any one of Supplementary Notes 3 to 5, the cutout portion may be formed in a manner so that the outline of the cutout portion extends in a straight line in a side view of the tubular portion.

According to such a configuration, the cooling gas can be efficiently mixed with the exhaust gas.

### Supplementary Note 7

In the gas mixing device according to any one of Supplementary Notes 2 to 6, the opening portions may extend along the circumferential direction of the tubular portion.

According to such a configuration, it is possible to make the cooling gas flow into the inside of the tubular portion in the circumferential direction of the tubular portion in a balanced manner by using the opening portions.

### Supplementary Note 8

In the gas mixing device according to Supplementary Note 7, the opening width of each of the opening portions in the axial direction of the tubular portion may increase with increasing distance from the cooling gas inlet port.

According to such a configuration, it is possible to make the cooling gas flow into the inside of the tubular portion in the circumferential direction of the tubular portion in a more balanced manner.

### Supplementary Note 9

In the gas mixing device according to any one of Supplementary Notes 2 to 8, the peripheral wall of the tubular portion may be provided with the restricting wall (74) configured to restrict the inflow direction of the cooling gas flowing into the inside of the tubular portion from the space via the opening portions.

According to such a configuration, since the inflow direction of the cooling gas flowing into the inside of the tubular portion is restricted, the exhaust gas and the cooling gas can be efficiently mixed inside the tubular portion.

### Supplementary Note 10

In the gas mixing device according to Supplementary Note 9, the restricting wall may protrude from the peripheral wall of the tubular portion toward the space.

According to such a configuration, the exhaust gas flowing inside the tubular portion can be made to flow smoothly as compared to a case where the restricting wall protrudes toward the inside of the tubular portion.

### Supplementary Note 11

In the gas mixing device according to Supplementary Note 10, the restricting wall may be provided so as to cover each of the opening portions, the intake port (76) configured to take in the cooling gas may be provided between the end portion of the restricting wall in the protruding direction of the restricting wall and the peripheral wall of the tubular portion, and the intake port may be directed in a direction from the other end portion toward the one end portion of the tubular portion.

According to such a configuration, since the inflow direction of the cooling gas flowing into the inside of the tubular portion can be made to follow the flow direction of the exhaust gas flowing inside the tubular portion, it is possible to suppress a situation in which the flow of the exhaust gas is hindered by the cooling gas.

### Supplementary Note 12

In the gas mixing device according to any one of Supplementary Notes 9 to 11, the restricting wall may extend along the circumferential direction of the tubular portion.

According to such a configuration, it is possible to further suppress the situation in which the flow of the exhaust gas is hindered by the cooling gas.

### Supplementary Note 13

The gas mixing device according to any one of Supplementary Notes 2 to 12 may further include the vortex generation suppressing wall (78) configured to suppress generation of a vortex of the cooling gas in the space.

According to such a configuration, since the vortex generation suppressing wall can suppress the generation of the vortex of the cooling gas in the space located outside the tubular portion, the situation in which the cooling gas stays in the space can be suppressed.

### Supplementary Note 14

In the gas mixing device according to Supplementary Note 13, the vortex generation suppressing wall may be provided on the inner surface of the accommodating portion.

According to such a configuration, the vortex generation suppressing wall can be easily provided.

### Supplementary Note 15

In the gas mixing device according to Supplementary Note 13 or 14, the vortex generation suppressing wall and the cooling gas inlet port may be located on opposite sides of the tubular portion.

According to such a configuration, the situation in which the cooling gas stays at a position relatively far from the cooling gas inlet port can be suppressed.

### Supplementary Note 16

In the gas mixing device according to Supplementary Note 15, the cutout portion may be formed in a part of the peripheral wall of the tubular portion, the part facing the side opposite to the cooling gas inlet port, and the vortex generation suppressing wall may be located so as to face the cutout portion.

According to such a configuration, the situation in which the cooling gas stays around the cutout portion can be suppressed.

### Supplementary Note 17

In the gas mixing device according to Supplementary Note 16, the vortex generation suppressing wall may extend along the axial direction of the tubular portion.

According to such a configuration, the generation of the vortex of the cooling gas can be efficiently suppressed.

### Supplementary Note 18

In the gas mixing device according to Supplementary Note 13, the vortex generation suppressing wall may be formed in a wing shape in a plan view.

According to such a configuration, the generation of the vortex of the cooling gas can be suppressed more efficiently.

### Supplementary Note 19

In the gas mixing device according to any one of Supplementary Notes 1 to 18, the internal combustion engine may be the axial gas turbine engine (32).

According to such a configuration, the exhaust gas of the axial gas turbine engine can be smoothly discharged.

### Supplementary Note 20

In the gas mixing device according to any one of Supplementary Notes 1 to 19, the cooling gas may flow through the radiator (42, 42a) before flowing into the gas mixing device.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A gas mixing device that mixes an exhaust gas discharged from an internal combustion engine and a cooling gas introduced from an outside of the internal combustion engine, the gas mixing device comprising:
a tubular portion; and
a cooling gas inlet port configured to introduce the cooling gas into a space located outside the tubular portion,
wherein one end portion of the tubular portion is provided with an exhaust gas inlet port configured to introduce the exhaust gas into an inside of the tubular portion,
another end portion of the tubular portion is provided with a mixed gas outlet port configured to lead out a mixed gas in which the exhaust gas and the cooling gas are mixed,
a plurality of opening portions configured to allow the cooling gas in the space to flow into the inside of the tubular portion are formed in a peripheral wall of the tubular portion, and
positions of the plurality of opening portions in an axial direction of the tubular portion are different from each other.

2. The gas mixing device according to claim 1, further comprising an accommodating portion configured to accommodate the tubular portion, wherein
the cooling gas inlet port is provided in the accommodating portion so as to face the peripheral wall of the tubular portion.

3. The gas mixing device according to claim 2, wherein
a cutout portion is formed in a part of the peripheral wall of the tubular portion, the part facing a side opposite to the cooling gas inlet port.

4. The gas mixing device according to claim 3, wherein
the cutout portion is provided in the other end portion of the tubular portion.

5. The gas mixing device according to claim 4, wherein
a cutout width of the cutout portion decreases from the other end portion toward the one end portion of the tubular portion.

6. The gas mixing device according to claim 3, wherein
the cutout portion is formed in a manner so that an outline of the cutout portion extends in a straight line in a side view of the tubular portion.

7. The gas mixing device according to claim 2, wherein
the opening portions extend along a circumferential direction of the tubular portion.

8. The gas mixing device according to claim 7, wherein
an opening width of each of the opening portions in the axial direction of the tubular portion increases with increasing distance from the cooling gas inlet port.

9. The gas mixing device according to claim 2, wherein
the peripheral wall of the tubular portion is provided with a restricting wall configured to restrict an inflow direction of the cooling gas flowing into the inside of the tubular portion from the space via the opening portions.

10. The gas mixing device according to claim 9, wherein
the restricting wall protrudes from the peripheral wall of the tubular portion toward the space.

11. The gas mixing device according to claim 10, wherein
the restricting wall is provided so as to cover each of the opening portions,
an intake port configured to take in the cooling gas is provided between an end portion of the restricting wall in a protruding direction of the restricting wall and the peripheral wall of the tubular portion, and
the intake port is directed in a direction from the other end portion toward the one end portion of the tubular portion.

12. The gas mixing device according to claim 9, wherein
the restricting wall extends along a circumferential direction of the tubular portion.

13. The gas mixing device according to claim 2, further comprising a vortex generation suppressing wall configured to suppress generation of a vortex of the cooling gas in the space.

14. The gas mixing device according to claim 13, wherein
the vortex generation suppressing wall is provided on an inner surface of the accommodating portion.

15. The gas mixing device according to claim 13, wherein
the vortex generation suppressing wall and the cooling gas inlet port are located on opposite sides of the tubular portion.

16. The gas mixing device according to claim 15, wherein
a cutout portion is formed in a part of the peripheral wall of the tubular portion, the part facing a side opposite to the cooling gas inlet port, and
the vortex generation suppressing wall is located so as to face the cutout portion.

17. The gas mixing device according to claim 16, wherein
the vortex generation suppressing wall extends along the axial direction of the tubular portion.

18. The gas mixing device according to claim 13, wherein
the vortex generation suppressing wall is formed in a wing shape in a plan view.

19. The gas mixing device according to claim 1, wherein
the internal combustion engine is an axial gas turbine engine.

20. The gas mixing device according to claim 1, wherein
the cooling gas flows through a radiator before flowing into the gas mixing device.
